(19) United States
(12) Patent Application Publication
(10) Pub. No.: US 2026/0366182 A1
(43) Pub. Date: Nov. 19, 2026

(54) WATER ELECTROLYSIS PLANT INCLUDING ONE OR MORE DEGASSERS IN SERIES WITH A STATIC MIXER IN THE SUPPLY PIPE

(71) Applicant: JOHN COCKERILL HYDROGEN BELGIUM, Seraing (BE)

(72) Inventors: Nicolas Maricau, Seraing (BE); Luc Vanhee, Seraing (BE)

(73) Assignee: JOHN COCKERILL HYDROGEN BELGIUM, Seraing (BE)

(21) Appl. No.: 19/487,006

(22) PCT Filed: May 31, 2024
(86) PCT No.: PCT/EP2024/065060

§ 371 Date: Nov. 24, 2025

(30) Foreign Application Priority Data
May 31, 2023 (BE) BE2023/5435

(51) Int. Cl. C25B 15/08; B01D 19/00; C25B 9/70

(52) U.S. Cl. CPC C25B 15/08; B01D 19/0057; B01D 19/0068; C25B 9/70

(57) ABSTRACT

A degassing device for an electrolysis plant is provided for the production of dihydrogen (H₂) and dioxygen (O₂) by electrolysis of water. The plant includes a degassing device (1, 101) which includes a degassing chamber (14, 114) provided with an opening for a gas-liquid mixture supply pipe (11, 111), with an opening for a liquid discharge pipe (12, 112) arranged below the level of the gas-liquid interface (15, 115) of the degassing chamber (14, 114), and with an opening for a gas discharge pipe (13, 113) arranged above the level of the gas-liquid interface (15, 115) of the degassing chamber (14, 114). Furthermore, a static mixer (21, 121) is inserted into the gas-liquid mixture supply pipe (11, 111).

The present invention pertains to the technical field of electrolysis and more particularly to an electrolysis plant for the production of dihydrogen (H₂) and dioxygen (O₂) by water electrolysis. According to one of its aspects, the invention relates to a degassing device which can be used in a plant for the production of dihydrogen and dioxygen by water electrolysis.

### INDICATION OF THE PRIOR ART

The need to reduce greenhouse gas production and to utilize renewable energies is now well known. Dihydrogen is an alternative to hydrocarbons because it is a readily storable energy carrier, unlike electricity, and its oxidation releases a very large energy (285 KJ/mol).

There are several known ways of producing gaseous dihydrogen; the most advantageous is to electrolyze the water molecule, as this is a high-yield reaction that does not directly produce CO₂, unlike the heavily used processes of methane, coal and hydrocarbon reforming.

There are three main types of electrolyzers known for water electrolysis:
alkaline electrolyzers (AWE), which are characterized by the use of a liquid electrolyte that allows the transfer of hydroxyl ions (OH) from the cathode to the anode;
high-temperature electrolyzers, whose electrolyte is a ceramic; and
membrane electrolyzers (PEM), whose electrolyte is a proton-conducting ion exchange membrane.

In all three cases, the system must be supplied with water of very high purity (supplying, in the case of alkaline electrolyzers, an electrolyte solution of sodium hydroxide (NaOH) or potassium hydroxide (KOH)). Although the remainder of the description, for reasons of brevity, will refer to an alkaline electrolyzer, it is appreciated that the present invention also applies to the membrane electrolyzer (for example, a proton exchange membrane).

According to the well-known process of the prior art, an electrolyte solution (known as the lye) is brought within a set of electrolytic cells (known as the electrolyzer stack) through a specific inlet. The electrolyte solution passes through the electrolyzer stack. Water is broken down into gaseous molecules of dihydrogen, H₂, at the cathode, and dioxygen, O₂, at the anode. A diaphragm usually separates the anode from the cathode so that, under normal conditions, the dihydrogen and dioxygen do not mix. The plant comprises an outlet for dihydrogen and electrolyte circulating on the cathode side (catholyte) and an outlet for dioxygen and electrolyte circulating on the anode side (anolyte). In other words, there are two separate streams, and so there is a gas-liquid separator dedicated to the separation of dihydrogen from the catholyte, and a gas-liquid separator for the separation of dioxygen from the anolyte. The liquid outlets of the two gas-liquid separators are then mixed before feeding the electrolyzer stack again. In both streams, at the outlet of the electrolyzer stack, the liquid phase (lye) is charged with gas bubbles. At the outlet of the gas-liquid separator, only a few gas bubbles remain in the lye evacuated through the lower orifice of the gas-liquid separator dedicated to the liquid phase, while the majority gas phase is extracted from the gas-liquid separator through the upper orifice of the gas-liquid separator. For various reasons, it is important to separate the gas from the lye. First of all, the more the gas is separated from the electrolyte, the greater the production of gas, which contributes to the good electrochemical yield of the process. Next, the H₂/O₂ mixture is highly explosive. If separation does not take place correctly, a significant amount of gas, commonly referred to as “residual gas”, is entrained at the liquid outlet of the gas-liquid separator. During the next circulation in the electrolyzer stack (the electrolyte rotates in a closed loop) some of this gas passes into the other compartment and therefore to the wrong side.

These gas-liquid separators, well known in the art, comprise a degassing chamber having an opening for a gas-liquid mixture supply pipe, an opening for a liquid discharge pipe arranged below the level of the gas-liquid interface of the degassing chamber, and an opening for a gas discharge pipe arranged above the level of the gas-liquid interface of the degassing chamber. Each of the outlets of the electrolyzer stack for the dihydrogen-lye and dioxygen-lye mixtures respectively is connected to such a gas-liquid separator. FIGS. 1 and 2 schematically represent known gas-liquid separators aligned respectively along a horizontal or vertical principal axis A. Document FR-A1-2949479, for example, describes such separators. Document WO-A1-2020/254211 is another example thereof.

The principle of extraction of gas bubbles from the liquid phase is based on the Archimedes principle. The efficiency of the separation depends primarily on gravity and on the difference in density between the liquid and gas phases, but also on the viscosity (friction of the gas bubbles in the liquid part). The gas-liquid mixture must therefore reside long enough in the degassing chamber to allow all of the gas bubbles to be extracted from the lye. In the remainder of the description, gas-liquid separators of this kind will be designated by the term gravity gas-liquid separators. These gravity gas-liquid separators are characterized by substantial dimensions. In some gas-liquid separators, equipment can be inserted to speed up separation (for example, a honeycomb structure) or to homogenize the flow and have a uniform residence time for all streamlines. Gas bubbles still present in the liquid phase can be quantitatively significant; in other words, not all the gas bubbles manage to be extracted from the liquid phase so as to be evacuated by an ad hoc discharge pipe on the upper or side wall of the degassing chamber. This poses a number of problems. As already indicated above, the output of the electrolyzer stack suffers from this loss of gas. In addition, in conventional electrolysis plants, the two lye fractions discharged from the gas-liquid separator are combined and mixed in an intermediate tank before being fed back into the electrolyzer stack in a closed loop. Owing to incomplete separation, a potentially significant amount of residual dihydrogen and residual dioxygen may be fed back into the electrolyzer stack, so that the residual dioxygen is on the cathode side while the dihydrogen is directed to the anode. As already indicated, it is well known that the dihydrogen/dioxygen gas mixture is explosive even at a fairly low concentration and this situation is dangerous for personnel and the plant. The gases thus produced also have a very mediocre purity, which requires a complementary purification step.

One solution to this problem is to increase the size of the gas-liquid separators, which in turn gives rise to new problems, related to the additional cost, the complexity of manufacturing and transporting these gas-liquid separators, and the increase in the size of the production works.

It would therefore be desirable to be able to provide a water electrolysis plant that allows virtually complete degassing of the discharges (dihydrogen/lye and dioxygen/lye of the electrolytic cells). Ideally, a water electrolysis plant of this kind should be able to furnish the expected result when the system is operated at full load (high discharge flow rate) or at reduced load (low discharge flow rate).

Indeed, it should also be taken into account that gas-liquid separators in electrolyzers do not always produce dihydrogen and dioxygen at their nominal load (unlike similar systems for other industries or applications) and that the system must be efficient regardless of the amount of gas to be separated. This is because, when the volume of gas decreases, the purity of the gases goes down since proportionally the coalescence of the gas bubbles, which are larger and easier to extract, is not the same.

Mixers intended to promote intimate mixing of two constituents are already known in the prior art (see, for example, document WO-A1-2013/126346).

### DISCLOSURE OF THE INVENTION

According to the invention, this problem is solved with a plant as defined in claim 1. A static mixer is a device for continuously mixing fluids or fluids and materials in another phase (solid or gas). This device allows mixing of the elements, but it can also be used with gases or for mixing a gas and a liquid. It is particularly surprising that such a mixing device can be used to achieve the opposite effect, namely, separating the gas from the liquid rather than mixing them. The inventors have observed that, under the effect of the static mixer, the gas-lye mixture which passes through the static mixer is subjected to very strong turbulence. In the present case, this turbulence must not break the gas bubbles already formed and so create the opposite effect. Therefore, with the proposed solution, only small gas bubbles remain in the static mixer. In turn, this turbulence causes the gas bubbles contained in the mixture to coalesce, which promotes the formation of larger gas bubbles which can subsequently be extracted more easily from the liquid in the gravity gas-liquid separator downstream of the static mixer. The gas separation mechanism follows the same scheme as that developed in a gravity gas-liquid separator, namely that i) the gas bubbles rise to the gas-liquid interface owing to gravity and the liquid-gas density ratio and end their travel by being discharged through the thus-dedicated gas discharge pipe located in the upper part of the degassing chamber; and ii) the liquid phase flows through the liquid discharge pipe located in the lower part of the degassing chamber.

There are many static mixers that can be used according to the invention. Document U.S. Pat. No. 3,286,992 describes the operating principle of the static mixer. The geometries of such mixers that may be suitable are numerous: helical, twisted, perforated ribbons, with barbs or spikes, and wire windings, fins and swirl generators, also called swirlers, etc. Advantageously, the static mixer is formed by a helical insert. According to another advantageous variant of the invention, the static mixer is formed by a swirler. The reason is that these two types of static mixers convert part of the translational energy of the flow into rotational energy and allow strong coalescence of the gas bubbles, which can then be extracted more easily from the liquid.

The invention therefore relates to a water electrolysis plant which contains one or more electrolyzer stacks and a degassing device as described above, the latter being defined by the coupling between a static mixer and a separator (gravity or cyclonic) downstream of the static mixer. The degassing device is supplied by the supply pipe, which is connected to a liquid phase discharge pipe of at least one electrolyzer stack. As explained above, such a device allows efficient and rapid separation of the gas-liquid mixture to the point that the size of the degassing device can be reduced.

According to one advantageous variant of the invention, the plant comprises an additional degassing device upstream or downstream of the degassing device defined above. A first degassing device is supplied by a supply pipe which is connected to a discharge pipe of at least one electrolyzer stack. There, only the large gas bubbles are discharged and their rupture in the static mixer is eliminated. The first gas-liquid separator is then small in size, so that only gas bubbles larger than 300 μm (ideally than 200 or 100 μm) are separated. The liquid discharge pipe of the first degassing device is connected to the supply pipe of a second degassing device. The two degassing devices are therefore arranged in series. A static mixer is arranged in the supply pipe of the first degassing device, in the supply pipe of the second degassing device or in both supply pipes.

The two degassing devices mounted in series may be aligned respectively along a horizontal or vertical main axis A in all possible combinations (horizontal-horizontal, horizontal-vertical, vertical-horizontal or vertical-vertical).

Provision may also be made to add one or more additional degassing devices.

The preferred and simplest solution is that in which the gas/liquid flow arrives in the first gas-liquid separator, in which the largest gas bubbles and the largest quantity of gas are extracted, before realizing coalescence in the conduit connecting this gas-liquid pre-separator to a second gas-liquid separator (conduit fitted with a static mixer). The static mixer can then generate very strong agitation without risking the rupture of large gas bubbles already formed. The two gas outlets can be connected and processed together. In this case, because of the communicating vessels, the two levels of the gas-liquid separators must be identical.

### BRIEF DESCRIPTION OF THE FIGURES

The invention will now be described by means of the figures, which have no other purpose than that of illustrating the present invention. In these figures, schematically:

FIG. 1 represents a degassing device for a horizontally arranged water electrolysis plant according to the prior art;

FIG. 2 represents a degassing device for a vertically arranged water electrolysis plant according to the prior art;

FIG. 3 represents a degassing device for a horizontally arranged water electrolysis plant according to the invention;

FIG. 4 represents a degassing device for a vertically arranged water electrolysis plant according to the invention;

FIGS. 5 and 6 represent two partial representations of an electrolysis plant with two degassing devices in series (preferred solution and simplest in efficiency).

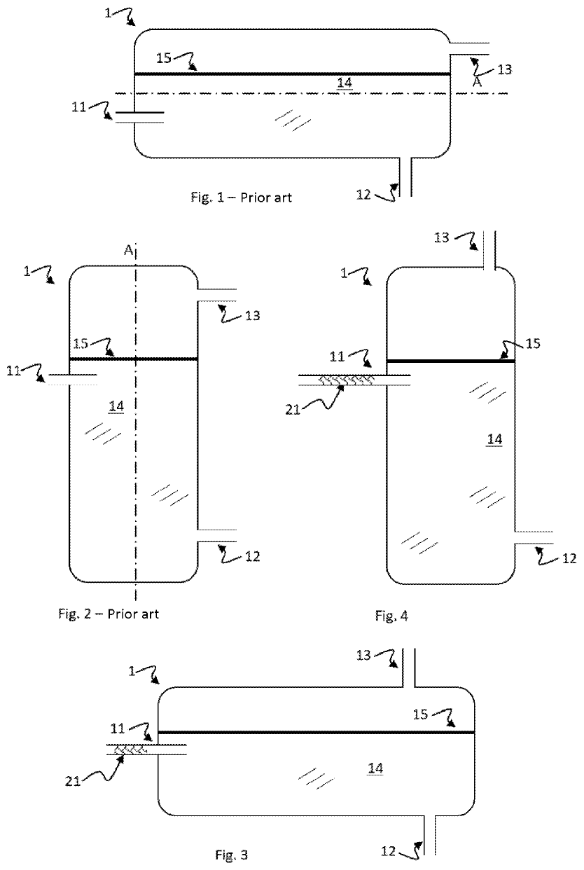

FIGS. 1 to 4 represent various degassing devices 1 for a water electrolysis plant. All contain a degassing chamber 14. For example, gas-water or gas-lye. The gas may be dihydrogen or dioxygen. The degassing chamber 14 is supplied by a supply pipe 11 for the gas-liquid mixture coming from the electrolyzer stack. In some cases (not represented in the figures), the degassing chamber 14 can also be supplied with a gas-liquid mixture coming from the liquid discharge pipe 12 of the degassing chamber 14 by means of a loop controlled by a valve, if a sensor has detected that the quantity of gas present in the discharge from the degassing chamber 14 was greater than a predetermined value. The degassing chamber 14 also comprises a gas discharge pipe, gas having been separated from the liquid phase, which can then either be discharged from the plant or reunited with the same gas from the electrolyzer stack. It will be noted that the gas discharge pipe 13 is always arranged above the gas-liquid interface 15. It may be located, for example, in the upper wall or in the or a side wall of the degassing chamber 14. Similarly, the liquid discharge pipe 12 is always arranged below the gas-liquid interface 15. It may be located, for example, in the lower wall (bottom wall) or in the or a side wall of the degassing chamber 14. The precise location of the discharge pipe 12 or 13 is not critical, but care must be taken to ensure that no vortex can form there that can entrain gas. A vortex-breaking device is then a plus to prevent this phenomenon. It is seen, however, that in all the cases represented, the discharge pipe 12 or 13 has been arranged on the opposite side, that is to say at the furthest distance from the supply pipe 11 of the degassing chamber 14, in order to allow a longer path of the liquid in the degassing device 1. It is also seen that the degassing device can be arranged along a horizontal (FIGS. 1 and 3) or vertical axis A (FIGS. 2 and 4) depending on construction requirements, for example.

The degassing devices represented in FIGS. 3 and 4 have a static mixer 21 in their supply pipe.

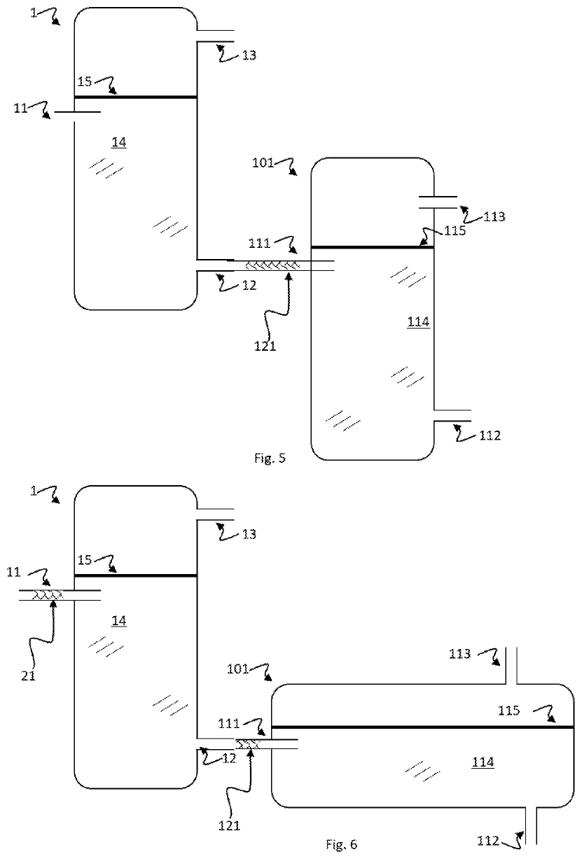

FIGS. 5 and 6 represent the assembly of two degassing devices mounted in series. The first of the two degassing devices 1 contains a degassing chamber 14. For example, gas-water or gas-lye. The gas may be dihydrogen or dioxygen. The degassing chamber 14 is supplied by a supply pipe 11 for the gas-liquid mixture coming from the electrolyzer stack. The degassing chamber 14 also comprises a gas discharge pipe 13 and a liquid discharge pipe 12. The assemblies of FIGS. 5 and 6 also contain a second degassing device 101 mounted in series with the first degassing device 1. The second degassing device 101 contains a degassing chamber 114 supplied by a supply pipe 111 for the gas-liquid mixture coming from the liquid discharge pipe 12 of the first degassing device 1. The degassing chamber 114 also comprises a gas discharge pipe 113 and a liquid discharge pipe 112. It is seen in FIGS. 5 and 6 that the gas-liquid mixture supply pipe 111 of the second degassing device 101 contains a static mixer 121.

In FIG. 6, it is seen that the gas-liquid mixture supply pipe of the first degassing device 1 also contains a static mixer 21. The two gas outlets can be connected for common processing. In this case, care will be taken to adjust the two free surface areas because of the twin communication (gas and liquid).

### LIST OF DRAWING REFERENCES

1 Gas-liquid separator
11 Gas-liquid mixture supply pipe
12 Liquid discharge pipe
13 Gas discharge pipe
14 Gas-liquid separation chamber
15 Gas-liquid interface
21 Static mixer
101 Gas-liquid separator
111 Gas-liquid mixture supply pipe
112 Liquid discharge pipe
113 Gas discharge pipe
114 Gas-liquid separation chamber
115 Gas-liquid interface
121 Static mixer
A Main axis of the separator

1. A water electrolysis plant or any other constituent containing one or more electrolyzer stacks and a degassing device (1, 101), wherein the degassing device (1, 101) comprises a degassing chamber (14, 114) having
an opening for a gas-liquid mixture supply pipe (11, 111);
an opening for a liquid discharge pipe (12, 112) arranged below the level of the gas-liquid interface (15, 115) of the degassing chamber (14, 114);
an opening for a gas discharge pipe (13, 113) arranged above the level of the gas-liquid interface (15, 115) of the degassing chamber (14, 114), a static mixer (21, 121) being inserted in the gas-liquid mixture supply pipe (11, 111), and wherein the degassing device (1, 101) is supplied via a supply pipe (11, 111) which is connected to a gas-electrolyte mixture discharge pipe of at least one electrolyzer stack.

2. The water electrolysis plant as claimed in claim 1, wherein the static mixer (21, 121) is formed by a helical insert.

3. The water electrolysis plant as claimed in claim 1, wherein the static mixer (21, 121) is formed by a swirler.

4. The water electrolysis plant containing one or more electrolyzer stacks as claimed in claim 1 and further comprising two or more degassing devices (1, 101) mounted in series.

5. The water electrolysis plant containing one or more electrolyzer stacks as claimed in claim 2 and further comprising two or more degassing devices (1, 101) mounted in series.

6. The water electrolysis plant containing one or more electrolyzer stacks as claimed in claim 3 and further comprising two or more degassing devices (1, 101) mounted in series.
